(19) United States
(12) Patent Application Publication
(10) Pub. No.: US 2025/0116572 A1
(43) Pub. Date: Apr. 10, 2025

(54) WHEEL BEARING ASSEMBLY FOR TESTING VEHICLES

(71) Applicant: Honda Motor Co., Ltd., Tokyo (JP)

(72) Inventors: BENJAMIN BOWLBY, DUBLIN, OH (US); JACLYN DIGLIO, PLAIN CITY, OH (US); PIROOZ MORADNIA, DUBLIN, OH (US); HUGH TIMOTHY FEEHAN, RICHMOND, VA (US); JOSEPH B. NELSON, RAYMOND, OH (US)

(21) Appl. No.: 18/481,766

(22) Filed: Oct. 5, 2023

(51) Int. Cl. G01M 17/013; G01M 9/00; G01M 13/04

(52) U.S. Cl. CPC G01M 17/013; G01M 9/00; G01M 13/04

(57) ABSTRACT

A wheel bearing assembly is provided. The wheel bearing assembly includes a wheel releasably coupled to a vehicle to perform an aerodynamic testing of the vehicle. The wheel bearing assembly further includes a shaft adaptor coupled between a bearing of the wheel and other components of the vehicle. The shaft adaptor rotates the wheel independent of the control of other components of the vehicle.

### BACKGROUND

Vehicles may generally be tested for determination of various functionalities associated with components of the vehicles. For example, some components (such as wheels, wheel covers, windshield, etc.) may be aerodynamically tested to determine an aerodynamic drag/lift of such components of the vehicle. In certain cases, there may be a requirement to test a specific component (such as a wheel with a wheel cover and/or a wheel without a wheel cover) in the vehicle to selectively determine the aerodynamic drag/lift of such specific component. However, in an aerodynamic testing event, as the specific component (i.e., the wheel and the corresponding wheel cover) may be coupled to other components (for example, a powertrain, a braking assembly, etc.), it may be difficult for an operator to selectively determine the aerodynamic drag/lift of such component (i.e., the wheel and the corresponding wheel cover), without any interference from other components of the vehicle.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a wheel bearing assembly may be provided to perform an aerodynamic testing of a vehicle. The wheel bearing assembly may include a wheel releasably coupled to the vehicle. The wheel bearing assembly may further include a shaft adaptor coupled between a bearing of the wheel and other components of the vehicle. The shaft adaptor may be configured to rotate the wheel independent of the control of the other components of the vehicle.

According to another embodiment of the disclosure, an aerodynamic testing system may be provided to perform an aerodynamic testing of a vehicle. The aerodynamic testing system may include a wheel that may be releasably coupled to a vehicle to perform the aerodynamic testing of the vehicle, where the wheel may be disposed on a rolling platform. The aerodynamic testing system may further include a shaft adaptor that may be coupled between a bearing of the wheel and other components of the vehicle. The aerodynamic testing system may further include a wind tunnel associated with the vehicle and the rolling platform. The wind tunnel may be configured to rotate the wheel on the rolling platform, such that, the rotation of the wheel may be independent from the other components of the vehicle.

According to another embodiment of the disclosure, a method may be provided to perform an aerodynamic testing of a vehicle. The method may include coupling a wheel to the vehicle to perform the aerodynamic testing of the vehicle. The wheel may be configured to be releasably coupled to the vehicle. The method may further include coupling a shaft adaptor between a bearing of the wheel and other components of the vehicle. The shaft adaptor may be configured to rotate the wheel independent of control of the other components of the vehicle.

### BRIEF DESCRIPTION OF THE DRAWINGS

FIGS. 1A and 1B illustrate a wheel bearing assembly to perform an aerodynamic testing of a vehicle, in accordance with an embodiment of the disclosure.

FIG. 2 is a diagram that illustrates an exploded view of the wheel bearing assembly of FIG. 1, in accordance with an embodiment of the disclosure.

FIG. 3 is a diagram that illustrates an exemplary scenario to perform an aerodynamic testing of a wheel cover coupled to a wheel of a vehicle, via the wheel bearing assembly of FIG. 1, in accordance with an embodiment of the disclosure.

FIG. 4 is a diagram that illustrates a cross-sectional view of the wheel bearing assembly of FIG. 1, in accordance with an embodiment of the disclosure.

FIG. 5 illustrates a flowchart of an exemplary method to perform an aerodynamic testing of a vehicle, via the wheel bearing assembly of FIG. 1, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a wheel bearing assembly. Exemplary aspects of the disclosure may provide the wheel bearing assembly which may be coupled to a vehicle for testing aerodynamics of a specific component (for example, a wheel) of the vehicle. The wheel bearing assembly may include a wheel that may be releasably coupled to the vehicle. The wheel bearing assembly may further include a shaft adaptor coupled between a bearing of the wheel and other components of the vehicle. The shaft adaptor may be configured to isolate the wheel from other components of the vehicle, which allows the wheel to rotate independent of the control of the other components (for example powertrain, braking assembly, etc.) of the vehicle. Hence, there may not be a need to manually dissemble multiple components (such as, a power train, a brake assembly, etc.) of the vehicle to selectively test the specific component (such as, the wheel). Therefore, based on the wheel bearing assembly, there may be substantial time saved in testing the aerodynamics of the specific component of the vehicle, and further, there may also be a minimal damage to other components (for example, power train, brake assembly, etc.) of the vehicle.

Reference will now be made in detail to specific aspects or features, examples of which are illustrated in the accompanying drawings. Wherever possible, corresponding, or similar reference numbers will be used throughout the drawings to refer to the same or corresponding parts.

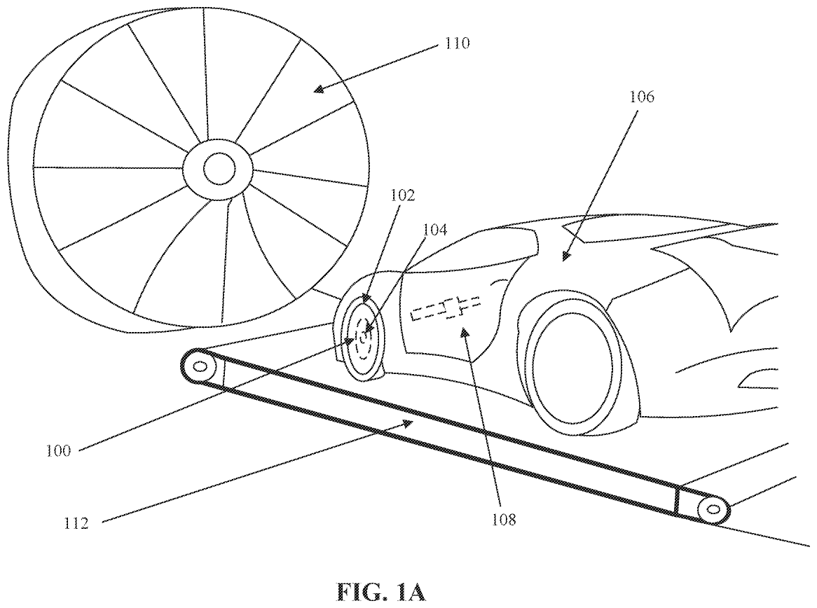

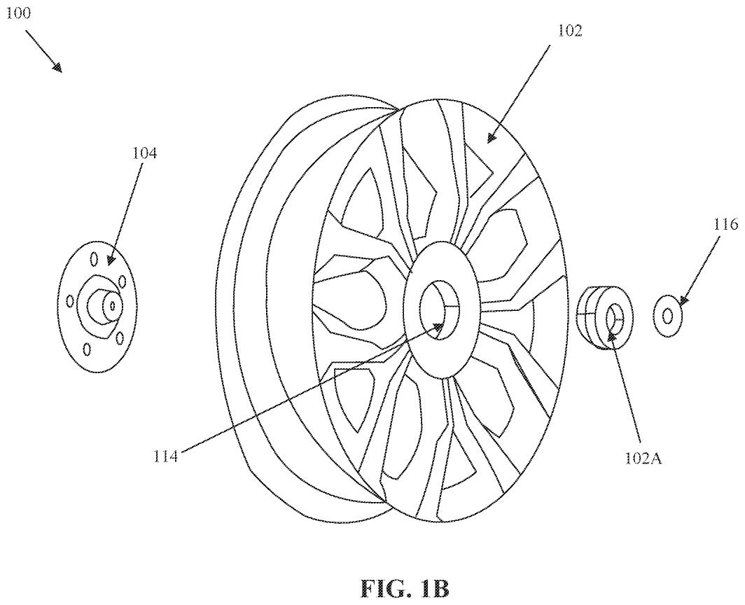

FIGS. 1A and 1B illustrate a wheel bearing assembly to perform an aerodynamic testing of a vehicle, in accordance with an embodiment of the disclosure. With reference to FIGS. 1A and 1B, there is shown a diagram that include a wheel bearing assembly 100. The wheel bearing assembly 100 may include: a wheel 102 with a bearing 102A (shown in FIG. 1B) and a shaft adaptor 104, which may be releasably coupled to a vehicle 106. The shaft adaptor 104 may be coupled between the bearing 102A of the wheel 102 and other components 108 of the vehicle 106. To perform the aerodynamic testing of the vehicle 106, the vehicle 106 may be placed against a wind tunnel 110, which may be configured to rotate the wheel 102 on a rolling platform 112 associated with the wind tunnel 110.

The wheel bearing assembly 100 may be coupled to the vehicle 106 to perform the aerodynamic testing of the vehicle 106. The wheel bearing assembly 100 may include the wheel 102, which may replace an original wheel of the vehicle 106. The wheel 102 associated with the wheel bearing assembly 100 may be manufactured based on structural aspects of the original wheel of the vehicle 106. For example, in case the original wheel of the vehicle 106 has a larger diameter than a diameter of a standard wheel, the wheel 102 may also be formed with such larger diameter to match the structural aspects of the original wheel of the vehicle 106. In an embodiment, the wheel may be manufactured via a rapid prototyping process, so that, there may be a minimal time that may be required to manufacture the wheel 102.

The structural aspects of the original wheel may include a dimension, a stiffness, an inertia, or a weight. For instance, if the dimension of the original wheel may be in the range of 14″ to 19″ and weight of the wheel ranges from 27 pound to 30 pound, then the wheel 102 made from the rapid prototyping process may have same dimension and weight. The structural aspects acquired on the wheel 102 may facilitate an optimal assembly of the wheel 102 with the vehicle 106 and provide accurate and similar conditions to that of the original wheel to perform the aerodynamic testing of the vehicle 106. Similarly, the same stiffness, inertia and/or weight of the wheel 102 may be required to provide accurate results of aerodynamic testing of the original wheel.

The shaft adaptor 104 may be configured to be coupled between the bearing 102A of the wheel 102 and the other component 108 of the vehicle 106. The shaft adaptor 104 may be configured to isolate the wheel 102 from the other components 108 of the vehicle 106, to allow rotation of the wheel 102 independent of control of the other components 108 of the vehicle 106. The bearing 102A of the wheel 102 may be an angular contact ball bearing, which may be disposed in a double row with a non-contact shield within a steel sheet metal cage. The bearing 102A may accommodate radial loads as well as axial loads in either direction of the shaft adaptor 104. The bearing 102A may be preferably used for distributing the load of the wheel 102 while moving at a high speed, and always remain in contact with the shaft adaptor 104.

The shaft adaptor 104 may establish a connection between the wheel 102 and the other components 108 of the vehicle 106. The shaft adaptor 104 may preferably have a circular cross section, whose one end may be fixed with the bearing 102A of the wheel 102 while the other end may be fixed with other components 108 of the vehicle 106. In an event of the aerodynamic testing of the vehicle 106, the shaft adaptor 104 may isolate the wheel 102 from the other components 108 of the vehicle 106. The isolation of the other components 108 of vehicle 106 may allow a selective determination of the aerodynamic drag/lift from the wheel 102 itself with no indulgence or interference of an aerodynamic contribution from the other components 108 of the vehicle 106.

The other components 108 may include a brake assembly (not shown) and a powertrain (not shown) associated with the vehicle 106. In the event of the aerodynamic testing of the vehicle 106, the shaft adaptor 104 may isolate the wheel 102 from the other components 108 of the vehicle 106. The wheel 102 may be configured to rotate independent of the brake assembly and the powertrain of the vehicle 106. The isolation of the wheel 102 from the brake assembly and the powertrain of the vehicle 106 may reduce chances of aerodynamic contribution of the brake assembly and the powertrain for testing the aerodynamic drag of the wheel 102.

The other components 108 may further include a vehicle-bearing (not shown) associated with the vehicle 106. The shafts adaptor 104 may be configured to rotate the bearing 102A of the wheel 102 independent of the vehicle-bearing associated with the vehicle 106. The isolation of the bearing 102A of the wheel 102 from the vehicle-bearing may isolate the wheel 102 from the vehicle-bearing. The isolation of the wheel 102 may facilitate the wheel 102 to independently rotate from the vehicle-bearing of the vehicle 106, limiting aerodynamic contribution of the vehicle-bearing of the vehicle 106.

In the event of the aerodynamic testing of the vehicle 106, the other components 108 (for example a brake assembly, a powertrain and a vehicle-bearing) may be isolated from the wheel 102, to reduce the aerodynamic contribution of the other components 108. As the wheel 102 is isolated from the powertrain of the vehicle 106, it may require external source to rotate to perform the aerodynamic testing of the wheel 102. In such instances, the vehicle 106 may be placed adjacent to the wind tunnel 110 to rotate the wheel 102 and perform the aerodynamic testing of the wheel 102. The wind tunnel 110 may facilitate an air flow that may be configured to rotate the wheel 102 on the rotating platform 112, to determine an effect of the air flow (for example aerodynamic forces, etc.) that rotates the wheel 102 of the vehicle 106.

The wind tunnel 110 may relate to a machinery, which is configured to generate the air flow and direct the generated air flow towards the wheel 102 that may be independently held in the vehicle 106, to study the interaction between the wheel 102 and generated airflow. The wind tunnel 110 may be activated to spin and/or rotate the wheel 102 independent from other components 108 of the vehicle 106. For example, the wind tunnel 110 may be configured to rotate the wheel 102 independent of the brake assembly and the powertrain of the vehicle 106. Similarly, the vehicle-bearing may isolate from the bearing 102A of the wheel 102, and the wind tunnel 110 may rotate the bearing 102A of the wheel 102 independent of the vehicle-bearing. The isolation of the wheel 102 from the other components 108 of the vehicle 106, may allow the wind tunnel 110 to rotate the wheel 102 freely or independently based on the airflow from the wind tunnel 110. Such isolation of the wheel 102 may reduce the aerodynamic contribution of the other components 108 in performing the aerodynamic testing of the wheel 102.

The rolling platform 112 may be configured to spin or rotate the wheel 102 due to air flow from the wind tunnel 110. The rolling platform 112 may be placed underneath the vehicle 106 to act as a treadmill for the vehicle 106. In the event of the aerodynamic testing of the vehicle 106, the wind tunnel 110 may be activated to rotate the wheel 102 about its central axis and the rolling platform 112 may start moving based on the rotation of the wheel 102. The rolling platform 112 may also simulate various conditions of a road for the wheel 102 during the aerodynamic testing. With continuous air flow from the wind tunnel 110, the wheel 102 may independently rotate on the rolling platform 112 and corresponding information associated with the independent rotation of the wheel 102 may be collected to perform the aerodynamic testing on the vehicle 106.

The wheel 102 may be provided with a center bore 114, which may accommodate the bearing 102A that may be press-fit along with a slip ring 116. The slip ring 116 may hold the bearing 102A in the center bore 114 of the wheel 102, which may limit slipping of the bearing 102A while performing the aerodynamic testing of the vehicle 106.

In operation, the wheel bearing assembly 100 may include the wheel 102 configured to be releasably coupled to the vehicle 106. The original wheel of the vehicle 106 may be replaced with the wheel 102 associated with the wheel bearing assembly 100. The wheel 102 may be manufactured with the structural aspects of the original wheel in terms of dimension, stiffness, inertia, or weight. The wheel bearing assembly 100 may further include the shaft adaptor 104 which may be coupled between the bearing 102A of the wheel 102 and other components 108 of the vehicle 106 (for example a brake assembly, a power train, a vehicle bearing, etc.). In the event of the aerodynamic testing of the vehicle 106, the shaft adaptor 104 may isolate the wheel 102 from the other components 108 of the vehicle 106, to reduce the aerodynamic contribution of the other components 108 to perform the aerodynamic testing of vehicle 106. The activation of the wind tunnel 110 may generate the air flow towards the vehicle 106 which may spin or rotate the wheel 102 over the rolling platform 112 and information associated with the rotation of the wheel 102 may be collected to determine the aerodynamic drag/lift on the vehicle 106.

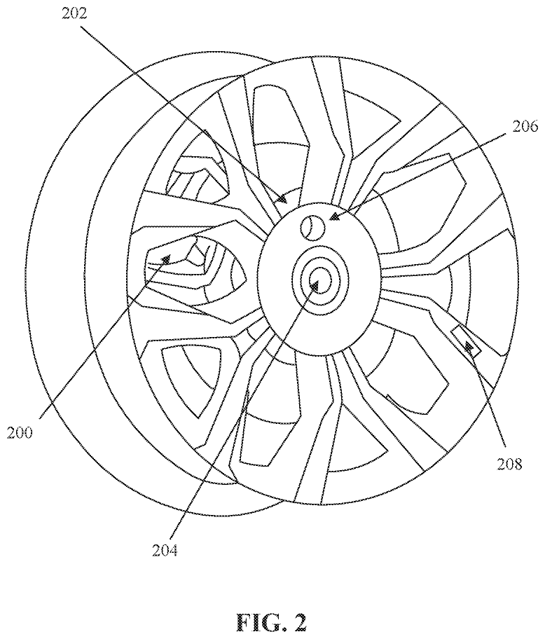

FIG. 2 is a diagram that illustrates an exploded view of the wheel bearing assembly of FIG. 1, in accordance with an embodiment of the disclosure. With reference to FIG. 2, there is shown a diagram that include a housing 200 which may be configured to enclose all components of the wheel bearing assembly 100, to provide a protection to the components of the wheel bearing assembly 100. The housing 200 may be mounted on a hub portion of the vehicle 106 (shown in FIG. 1A), where the shaft adaptor 104 (shown in FIGS. 1A-1B) may connect the bearing 102A (shown in FIG. 1B) of the wheel 102 (shown in FIGS. 1A-1B) with the other components 108 of the vehicle 106.

The housing 200 may be coupled with a brake rotor 202 of the wheel 102 via a vehicle lug nut 204, to facilitate isolation of the wheel 102 from the brake assembly of the vehicle 106. The brake rotor 202 of the vehicle 106 may be secured underneath to the hub of the vehicle 106 using the vehicle lug nut 204. The brake rotor 202 may be configured within an access hole 206 that may be provided on the wheel bearing assembly 100 of the vehicle 106. The access hole 206 may be configured to receive the vehicle lug nut 204, to ensure an optimal alignment of the wheel 202 with the vehicle 106. In another embodiment, the housing 200 may be mounted over the brake rotor 202 via a suitable fastening arrangement, for example, a screw, a bolt, and the like. In another embodiment, the fastening arrangement may preferably be the vehicle lug nut 204, which may facilitate the wheel 102 to independently rotate from the other components 108 of the vehicle 106. In another embodiment, the wheel 102 may include a selective reinforcement 208 in accordance with structural aspects of the original wheel. In an embodiment, the selective reinforcement 208 may be configured on the wheel 102 while manufacturing using the rapid prototyping. The selective reinforcement 208 may be introduced or formed at the specific locations on the wheel 102, preferably on spokes of the wheel 102, to maintain stability of the wheel 102.

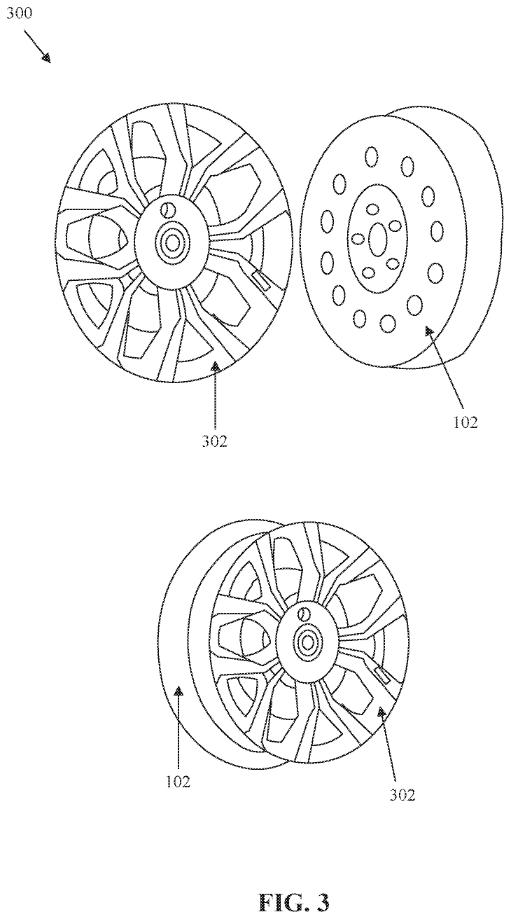

FIG. 3 is a diagram that illustrates an exemplary scenario to perform an aerodynamic testing of a wheel cover coupled to a wheel of a vehicle, via the wheel bearing assembly of FIG. 1, in accordance with an embodiment of the disclosure. With reference to FIG. 3, there is shown a diagram that may include the wheel cover 302 along with the wheel 102. In certain cases of the aerodynamic testing of the wheel 102, there may be requirement to test the wheel cover 302 to determine the aerodynamic contribution of the wheel cover 302 over the aerodynamics of the wheel 102. The exemplary scenario may be illustrated as implementation of two scenarios including the wheel 102 with the wheel cover 302 and/or the wheel 102 without the wheel cover 302, to selectively determine the aerodynamic contribution of the wheel cover 302.

In first implementation, the wheel 102 may be assembled with the wheel cover 302 for aerodynamic testing of the vehicle 106. The original wheel may be replaced with the wheel 102 along with the wheel cover 302. The shaft adaptor 104 (shown in FIGS. 1A-1B) may isolate the wheel 102 along with the wheel cover 302, from the other components 108 of the vehicle 106. The isolation of the wheel 102 along with the wheel cover 302, may allow the rotation of the wheel 102 along with the wheel cover 302 independent of the other components 108 of the vehicle 106. The isolation of the wheel 102 along with the wheel cover 302, may reduce the aerodynamic contribution of the other components 108 in determination of the aerodynamic drag/lift of vehicle 106 due to the wheel 102 with the wheel cover 302. The activation of the wind tunnel 110 (shown in FIG. 1A) may provide the air flow towards the vehicle 106, which may spin or rotate the wheel 102 and wheel cover 302, over the rolling platform 112 (shown in FIG. 1A) and the information associated with such rotation may be collected to determine the aerodynamic drag/lift of the vehicle 106 due to wheel 102 with the wheel cover 302.

In second implementation, the wheel 102 may be assembled without the wheel cover 302 in the event of the aerodynamic testing of the vehicle 106. The original wheel may be replaced with the wheel 102. The shaft adaptor 104 may isolate the wheel 102 from the other components 108 of the vehicle 106, allowing rotation of the wheel 102 independent of the other components 108 of the vehicle 106. The isolation of the wheel 102 from the other components 108 of the vehicle 106, may reduce the aerodynamic contribution of the other components 108 in determination of the aerodynamic drag of the vehicle 106 due to the wheel 102. The activation of the wind tunnel 110 may provide the air flow towards the vehicle 106, which may spin or rotate the wheel 102 over the rolling platform 112 and the information associated with such rotation may be collected to determine the aerodynamic drag/lift of the vehicle 106 due to the wheel 102.

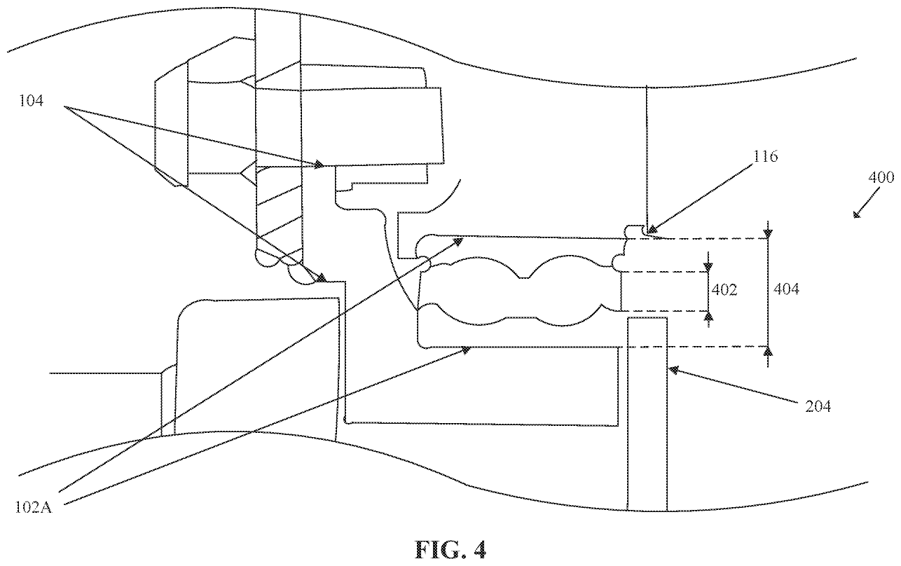

FIG. 4 is a diagram that illustrates a cross-sectional view of the wheel bearing assembly of FIG. 1, in accordance with an embodiment of the disclosure. With reference to FIG. 4, there is shown a diagram that may illustrate a bearing 102A having a bearing diameter 400. The bearing diameter 400 have a plurality of dimensions, for example, a minimum shaft shoulder diameter 402 and a maximum house shoulder diameter 404. The minimum shaft shoulder diameter 402 may be provided in a range of 35 mm-50 mm. Similarly, the maximum house shoulder diameter 404 may be provided in a range of 60 mm-80 mm. The shoulders for the inner and outer ring of the bearing 102A may allow better axial load to be transferred without tilting of the ring associated with the bearing 102A.

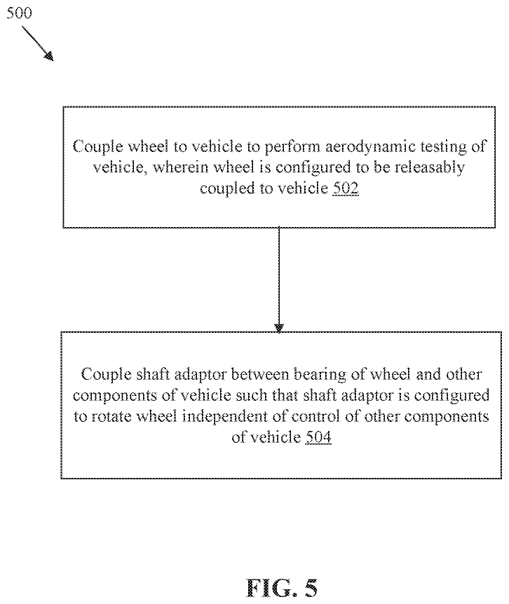

FIG. 5 illustrates a flowchart of an exemplary method to perform an aerodynamic testing of a vehicle, via the wheel bearing assembly of FIG. 1, in accordance with an embodiment of the disclosure. FIG. 5 is explained in conjunction with FIGS. 1A, 1B, 2, 3, and 4. With reference to FIG. 5, there is shown a flowchart 500 that depicts an exemplary method for testing the aerodynamics of the wheel 102. The method illustrated in the flowchart 500 may start from 502.

At 502, the wheel 102 may be coupled to the vehicle 106 to perform the aerodynamic testing of the wheel 102, such that, the wheel 102 is releasably coupled to the vehicle 106. In an embodiment, the wheel bearing assembly 100 or the operator may couple the wheel 102 to the vehicle 106 to perform the aerodynamic testing of the wheel 102, as described, in detail, for example, in FIGS. 1A, 1B, and 2.

At 504, the shaft adaptor 104 may be coupled between the bearing 102A of the wheel 102 and the other components 108 (for example brake assembly, power train, vehicle bearing, etc.) of the vehicle 106, such that, the shaft adaptor 104 may be configured to rotate the wheel 102 independent of control of the other components of the vehicle 106. In an embodiment, the wheel bearing assembly 100 or the operator may couple the shaft adaptor 104 between the bearing 102A of the wheel 102 and the other components 108 of the vehicle 106 as described, in detail, for example, in FIGS. 1A, 1B, and 2.

The flowchart 500 is illustrated as discrete operation of testing the aerodynamics of the vehicle, such as 502 and 504. However, in certain embodiments, such discrete operations may be further divided into additional operations, combined into fewer operations, or eliminated, depending on a specific implementation without any deviation from the scope of the disclosure.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A wheel bearing assembly, comprising:
a wheel configured to be releasably coupled to a vehicle to perform an aerodynamic testing of the vehicle; and
a shaft adaptor coupled between a bearing of the wheel and other components of the vehicle, the shaft adaptor is configured to rotate the wheel independent of control of the other components of the vehicle.

2. The wheel bearing assembly according to claim 1, wherein,
the other components comprise a brake assembly and a powertrain of the vehicle, and
the wheel is configured to rotate independent of the brake assembly and the powertrain of the vehicle.

3. The wheel bearing assembly according to claim 1, wherein,
the other components comprise a vehicle-bearing associated with the vehicle, and
the shaft adaptor is configured to rotate the bearing of the wheel independent of the vehicle-bearing.

4. The wheel bearing assembly according to claim 1, wherein,
the wheel is manufactured based on a structural aspect of an original wheel of the vehicle, via a rapid prototyping process, and
the wheel is replaced with the original wheel to perform the aerodynamic testing of the vehicle.

5. The wheel bearing assembly according to claim 4, wherein,
the structural aspect of the original wheel may include one of: a dimension, a stiffness, an inertia, or a weight of the original wheel.

6. The wheel bearing assembly according to claim 1, wherein,
the aerodynamic testing of the vehicle comprises an independent rotation of the wheel of the vehicle from the other components of the vehicle, based on an activation of a wind tunnel against the vehicle.

7. The wheel bearing assembly according to claim 6, wherein,
the vehicle is placed on a rolling platform, and
the wheel of the vehicle is configured to independently rotate on the rolling platform from the other components of the vehicle, based on the activation of the wind tunnel against the vehicle and the rolling platform.

8. The wheel bearing assembly according to claim 1, further comprising,
a slip ring configured to hold the bearing of the wheel in a center bore of the wheel, based on a press-fit of the slip ring and the bearing in the center bore of the wheel.

9. The wheel bearing assembly according to claim 1, wherein,
the wheel may further include selective reinforcements based on a structural aspect of an original wheel of the vehicle, via a rapid prototyping process, and
the selective reinforcements are formed at specific locations of the wheel to maintain a stability of the wheel.

10. The wheel bearing assembly according to claim 9, wherein,
the structural aspect of the original wheel may include one of: a dimension, a stiffness, an inertia, or a weight of the original wheel.

11. The wheel bearing assembly according to claim 1, further comprising
an access hole configured to receive a vehicle lug nut and secure a brake rotor underneath to a hub of the vehicle.

12. The wheel bearing assembly according to claim 11, further comprising
a housing configured to enclose all components of the wheel bearing assembly, wherein the housing is further configured to be coupled to the brake rotor via the vehicle lug nut and facilitate the wheel to independently rotate from the other components of the vehicle.

13. The wheel bearing assembly according to claim 1, wherein,
the bearing of the wheel is an angular contact ball bearing, which is disposed in a double row with a non-contact shield within a steel sheet metal cage.

14. The wheel bearing assembly according to claim 1, wherein,
the wheel comprises a wheel cover, which is configured to be releasably coupled to the wheel to selectively perform the aerodynamic testing of the vehicle.

15. The wheel bearing assembly according to claim 1, wherein,
the bearing of the wheel has a minimum shaft shoulder diameter in a first range from 35 mm-50 mm, and
the bearing of the wheel has a maximum house shoulder diameter in a second range from 60 mm-80 mm.

16. An aerodynamic testing system, comprising:
a wheel configured to be releasably coupled to a vehicle to perform an aerodynamic testing of the vehicle, which is disposed on a rolling platform;
a shaft adaptor coupled between a bearing of the wheel and other components of the vehicle; and
a wind tunnel associated with the vehicle and the rolling platform, wherein the wind tunnel is configured to rotate the wheel on the rolling platform, wherein rotation of the wheel is independent from other components of the vehicle.

17. The aerodynamic testing system according to claim 16, wherein,
the other components comprise a brake assembly and a powertrain of the vehicle, and
the wind tunnel is configured to rotate the wheel independent of the brake assembly and the powertrain of the vehicle.

18. The aerodynamic testing system according to claim 16, wherein,
the other components comprise a vehicle-bearing associated with the vehicle, and
the wind tunnel is configured to rotate the bearing of the wheel independent of the vehicle-bearing.

19. A method, comprising:
coupling a wheel to a vehicle to perform an aerodynamic testing of the vehicle, wherein the wheel is configured to be releasably coupled to the vehicle; and
coupling a shaft adaptor between a bearing of the wheel and other components of the vehicle, the shaft adaptor is configured to rotate the wheel independent of control of the other components of the vehicle.

20. The method according to claim 19, wherein,
the other components comprise a brake assembly and a powertrain of the vehicle, and
the wheel is configured to rotate independent of the brake assembly and the powertrain of the vehicle.
